(19) United States
(12) Patent Application Publication
(10) Pub. No.: US 2020/0212831 A1
(43) Pub. Date: Jul. 2, 2020

(54) MOTOR CONTROL DEVICE

(71) Applicant: KABUSHIKI KAISHA TOKAI RIKA DENKI SEISAKUSHO, Aichi (JP)

(72) Inventor: Yuichi KANO, Aichi (JP)

(21) Appl. No.: 16/633,052

(22) PCT Filed: Aug. 17, 2018
(86) PCT No.: PCT/JP2018/030484

§ 371 Date: Jan. 22, 2020

(30) Foreign Application Priority Data
Aug. 28, 2017 (JP) 2017-163107

(51) Int. Cl. H02P 25/032; H02P 7/29

(52) U.S. Cl. CPC H02P 25/032; H02K 7/063; H02P 7/29

(57) ABSTRACT

A motor control device includes a motor control unit that controls electric power to be supplied to a motor, a deriving unit that derives a determination ratio of electric power to be supplied to the motor based on a detection result of transient characteristics of terminal output of the motor obtained under a predetermined condition after electric power supply from the motor control unit to the motor is shut off, and an adjusting unit that adjusts electric power to be supplied to the motor based on the determination ratio.

### CROSS-REFERENCES TO RELATED APPLICATIONS

The present patent application claims the priority of Japanese patent application No. 2017/163107 filed on Aug. 28, 2017, the entire contents of which are hereby incorporated by reference.

### TECHNICAL FIELD

The present invention relates to a motor control device.

### BACKGROUND ART

There is a motor control device which is used for a fluid supply motor of an anti-brake system and determines that abnormality (sticking) is occurring when terminal voltage of the motor is not more than a threshold at a specified timing after the motor stops rotating (see, e.g., Patent Literature 1).

The motor control device is a device for detecting abnormality in a hydraulic pressure source device used to pump up and supply fluid from a reservoir of limited capacity using a motor-driven pump, and is provided with a first drive means which drives the motor for a first predetermined period of time which is long enough for the rotational speed of the motor to reach a substantially steady speed, a first determination means which determines whether or not at least one of sticking of the pump and fluid leakage into the reservoir is occurring, based on a gradual or rapid decrease in terminal voltage of the motor immediately after the first drive means stops driving the motor, a second drive means which, after the determination by the first determination means, drives the motor for a second predetermined period of time which is longer than the first predetermined period of time and is enough to pump out all fluid from the reservoir fully filled with the fluid, and a second determination means which determines whether or not sticking of the pump is occurring, based on a gradual or rapid decrease in the terminal voltage of the motor immediately after the second drive means stops driving the motor.

### CITATION LIST

### Patent Literature

Patent Literature 1: JP 3/96469 A

### SUMMARY OF INVENTION

### Technical Problem

The motor control device disclosed in Patent Literature 1 only determines the existence of abnormality, so that it may be problematic in terms of failing to control the motor to have a specified output.

It is an object of the invention to provide a motor control device that can meet a specified motor output even when characteristics of the motor degrade.

### Solution to Problem

According to an embodiment of the invention, a motor control device is configured as defined by [1] to [10] below.

[1] A motor control device, comprising: a motor control unit that controls electric power to be supplied to a motor; a deriving unit that derives a determination ratio of electric power to be supplied to the motor based on a detection result of transient characteristics of terminal output of the motor obtained under a predetermined condition after electric power supply from the motor control unit to the motor is shut off; and an adjusting unit that adjusts electric power to be supplied to the motor based on the determination ratio.

[2] The motor control device according to [1], wherein the deriving unit derives the determination ratio of electric power to be supplied to the motor based on an electromotive force generated in a terminal of the motor at the point when a predetermined time elapses after the electric power supply from the motor control unit to the motor is shut off.

[3] The motor control device according to [1], wherein the deriving unit derives the determination ratio of electric power to be supplied to the motor based on time from when the electric power supply from the motor control unit to the motor is shut off to when the electromotive force generated in the terminal of the motor drops to a specified voltage.

[4] The motor control device according to any one of [1] to [3], wherein the adjusting unit performs the adjustment when the determination ratio is not more than a threshold.

[5] The motor control device according to any one of [1] to [4], wherein the motor control unit performs PWM control to control a duty ratio of electric power to be supplied to the motor.

[6] The motor control device according to [5], wherein the adjusting unit decides the duty ratio so that voltage is increased by the amount decreased from a reference voltage to a detected voltage.

[7] The motor control device according to [5], wherein the adjusting unit decides the duty ratio and gain (voltage) so that voltage is increased by the amount decreased from a reference voltage to a detected voltage.

[8] The motor control device according to [6] or [7], wherein the adjusting unit comprises a correction table containing the determination ratios and the duty ratios associated therewith and decides the duty ratio based on the determination ratio by referencing the correction table.

[9] The motor control device according to any one of [1] to [8], wherein, when the determination ratio is not more than a specified value, the adjusting unit determines that abnormality is occurring in the motor.

[10] The motor control device according to any one of [1] to [9], wherein the motor comprises a vibration motor.

### Advantageous Effects of Invention

According to an embodiment of the invention, it is possible to provide a motor control device that can meet a specified motor output even when characteristics of the motor degrade.

### BRIEF DESCRIPTION OF DRAWINGS

FIG. 1 is an explanatory diagram illustrating the general configuration of a motor control device in an embodiment.

FIG. 2 is a timing diagram illustrating motor ON/OFF signal, motor control signal (PWM signal), state of rotating motion of motor, rotational speed of motor and terminal voltage of motor as initial characteristics of a motor.

FIG. 3 is a timing diagram illustrating motor ON/OFF signal, motor control signal (PWM signal), state of rotating motion of motor, rotational speed of motor and terminal voltage of motor as characteristics of the motor after degradation.

FIG. 4 is an explanatory diagram illustrating the motor control signal (PWM signal) used for the initial characteristics of the motor and the motor control signal (PWM signal) used after degradation of the motor.

FIG. 5 is an explanatory diagram illustrating an outer appearance of a vibration motor to which the motor control device in the embodiment is applied.

### DESCRIPTION OF EMBODIMENT

### Embodiment of the Invention

A motor control device 1 in an embodiment of the invention has a motor control unit 20 which controls electric power to be supplied to a motor 10, a deriving unit 30 which derives a determination ratio of electric power to be supplied to the motor 10 based on a detection result of transient characteristics of terminal output of the motor 10 which are obtained under a predetermined condition after electric power supply from the motor control unit 20 to the motor 10 is shut off, and an adjusting unit 45 which adjusts electric power to be supplied to the motor 10 based on the determination ratio. The motor control unit 20, the deriving unit 30 and the adjusting unit 45 can be constructed by partially or entirely using a control ECU (microcomputer) 40 (described later), and thus can share the circuit or configuration of the control ECU 40.

(Motor 10) The motor 10 is an electric motor rotated by an electromagnetic force and is described as a brushed DC electric motor in the present embodiment, even though the invention is applicable to various motors. One terminal 11 of the motor 10 is connected to a collector C of the motor control unit 20 and an input 31 of the deriving unit 30, and another terminal 12 is connected to a ground GND.

(Motor Control Unit 20)

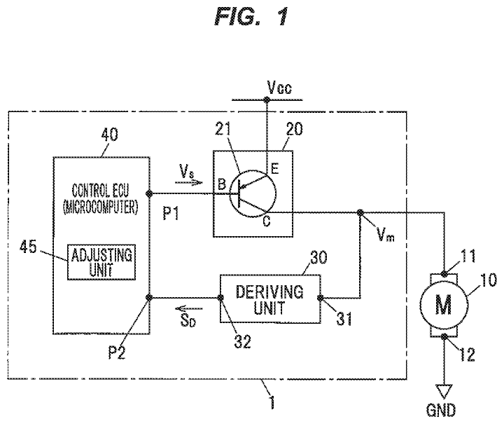

The motor control unit 20 controls electric power to be supplied to the motor and acts as a drive circuit which rotationally drives the motor 10 by supplying electric power (current) based on a motor control signal Vs output from the control ECU (microcomputer), as shown in FIG. 1. The motor control unit 20 is constructed from a transistor 21, as an example. The transistor 21 has a base B connected to an output port P1 of the control ECU 40 (microcomputer), an emitter E connected to a electric power source Vcc, and the collector C connected to the motor terminal 11.

The motor control signal Vs is input to the base B of the transistor 21 and a predetermined current corresponding to the motor control signal Vs is supplied to the motor 10. The motor control signal Vs is a PWM signal with modulated pulse width. Thus, electric power to be supplied depends on a predetermined voltage value and a duty ratio, and output of motor (rotational speed, torque, etc.) depends on the electric power to be supplied.

(Deriving Unit 30)

The deriving unit 30 has the input 31 connected to the terminal 11 of the motor 10 as well as to the collector C of the motor control unit 20, and an output 32 connected to an input port P2 of the control ECU 40 (microcomputer). The deriving unit 30 can detect voltage at the terminal 11 of the motor 10 based on a motor ON/OFF signal V_{ONOFF}. The voltage at the terminal 11 of the motor 10 can be detected as the sum of voltage supplied to the motor 10 and an electromotive force during rotation of the motor 10, and as the electromotive force generated by the motor 10 during the inertial rotation and the stopped state of the motor 10.

The deriving unit 30 can detect transient characteristics of terminal output of the motor 10. As an example, using the function of the control ECU 40 as a microcomputer, the deriving unit 30 can detect an electromotive force Vm of the motor 10 at the point when a specified time Δt elapses after electric power supply to the motor 10 is shut off.

The deriving unit 30 derives a determination ratio S_{D} of electric power to be supplied to the motor 10. The determination ratio S_{D} is derived based on detection of transient characteristics of terminal output of the motor 10 achieved by detecting the electromotive force Vm at the point when a specified time Δt elapses after electric power supply to the motor 10 is shut off. For example, a ratio of the motor terminal voltage Vm, which is obtained at the point when the time Δt elapses after the motor stops, with respect to the driving voltage of the motor 10 can be AD converted and output as the determination ratio S_{D} to the control ECU 40.

The detection of transient characteristics of terminal output of the motor 10 by the deriving unit 30 is not limited to the above-described detection of the electromotive force Vm of the motor 10 at the point when a specified time elapses after shutting off electric power supply to the motor 10. It may be detection of other transient characteristics, e.g., detection of time from when electric power supply to the motor 10 is shut off to when the electromotive force Vm of the motor 10 drops to a specified voltage.

(Adjusting Unit 45)

The adjusting unit 45 adjusts electric power to be supplied to the motor 10 based on the determination ratio S_{D} and comprises the function of the control ECU 40 as a microcomputer. The control ECU 40 (microcomputer) is, e.g., a microcomputer composed of a CPU (Central Processing Unit) performing calculation and processing, etc., of the acquired data according to a stored program, a RAM (Random Access Memory) and a ROM (Read Only Memory) as semiconductor memories, etc. The ROM as a memory stores the duty ratio for PWM control contained in a table so as to be associated with the electromotive force Vm described above and, as needed, is referenced at any time according to the stored program.

The adjusting unit 45 references the duty ratio corresponding to the determination ratio S_{D} and adjusts electric power to be supplied to the motor 10 based on the duty ratio. In detail, the pulse width of the motor control signal Vs is modulated to have a duty ratio corresponding to the determination ratio S_{D} and the motor control signal Vs (PWM signal) is then output from the output port P1 to the motor control unit 20, thereby adjusting electric power to be supplied to the motor 10.

(Operation of the Motor Control Device 1)

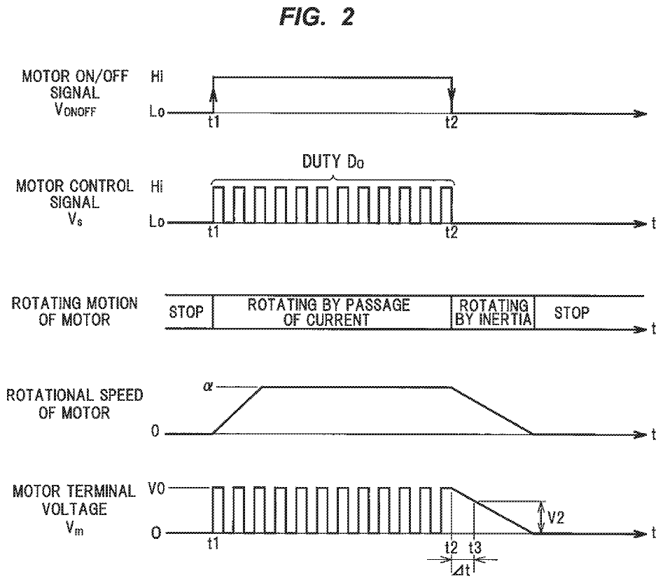

FIG. 2 shows the initial characteristics of the motor 10 and it is shown that the motor 10 is turned on (starts rotating) at time t1 and is turned off (stops rotating) at time t2. The initial characteristics here means characteristics when characteristic degradation of the motor due to aging degradation, etc., falls within a predetermined degradation range.

As shown in FIG. 2, the motor ON/OFF signal V_{ONOFF} transitions from Lₒ to Hᵢ at the time t1 and from Hᵢ to Lₒ at the time t2. The motor control signal Vs is output to drive the rotation at a predetermined duty ratio Do between the time t1 and the time t2.

When the motor 10 is drive-controlled by the motor control signal Vs as described above, the motor 10 exhibits rotational motion which is shown as the state of rotating motion of motor in FIG. 2. That is, the motor 10 is in the stopped state until the time t1 and rotates between the time t1 and the time t2 due to passage of current. From the time t2 onwards, the motor 10 rotates inertially and then stops since electric power is not supplied.

As shown in FIG. 2, the rotational speed of the motor 10 starts to rise at the time t1 and reaches a rotational speed α which is a predetermined initial characteristic. After electric power is shut off at the time t2, the rotational speed decreases and the motor 10 stops.

As shown in FIG. 2, the motor terminal voltage Vm is a driving voltage V0 applied between the time t1 and the time t2, but an electromotive force generated by inertial rotation of the motor is detected as the motor terminal voltage Vm after the time t2. The electromotive force (the motor terminal voltage Vm) is generated corresponding to the output of the motor and thus gradually decreases over time.

With the initial characteristics of the motor, the motor terminal voltage Vm drops to, e.g., voltage V2 from stop of the motor (the time t2) to time t3 which is the point when the time Δt elapses. When the motor terminal voltage Vm is, e.g., not less than the voltage V2 at the point when the time Δt elapses after the motor stops rotating, the transient characteristics of terminal output of the motor can be regarded as the initial characteristics.

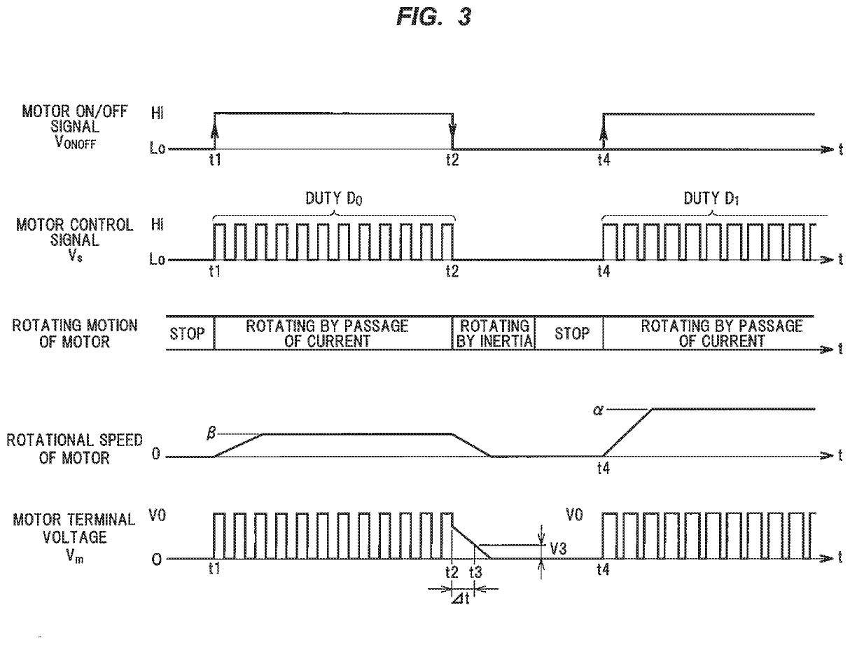

FIG. 3 shows characteristics of the motor after degradation, and similarly to FIG. 2, it is shown that the motor 10 is turned on (starts rotating) at the time t1 and is turned off (stops rotating) at the time t2. After degradation of the motor, electric power supply for the next time the motor 10 is turned on (starts rotating) is adjusted based on the detection result of the transient characteristics of the motor terminal output after the motor 10 is turned off (stops rotating), thereby correcting the output of the motor. The correction of the output of the motor means that the reduced output due to characteristics of the motor after degradation is corrected to fall within a predetermined output range which is obtained with the initial characteristics of the motor. The characteristics of the motor after degradation means characteristics when characteristic degradation of the motor due to aging degradation, etc., does not fall within a predetermined degradation range.

As shown in FIG. 3, the motor ON/OFF signal V_{ONOFF} transitions from Lₒ to Hᵢ at the time t1 and from Hᵢ to Lₒ at the time t2. The motor control signal Vs is output to drive the rotation at the predetermined duty ratio Do between the time t1 and the time t2.

When the motor 10 is drive-controlled by the motor control signal Vs as described above, the motor 10 exhibits rotational motion which is shown as the state of rotating motion of motor in FIG. 3. That is, the motor 10 is in the stopped state until the time t1 and rotates between the time t1 and the time t2 due to passage of current. From the time t2 onwards, the motor 10 rotates inertially and then stops since electric power is not supplied.

As shown in FIG. 3, the rotational speed of the motor 10 starts to rise at the time t1 and reaches a predetermined rotational speed β. After electric power is shut off at the time t2, the rotational speed decreases and the motor 10 stops.

Since the motor 10 here has characteristics after degradation, the predetermined rotational speed β mentioned above has a smaller value than the rotational speed α as output with the initial characteristics.

As a waveform of the motor terminal voltage Vm in FIG. 3 shows, an electromotive force generated by inertial rotation of the motor is detected as the motor terminal voltage Vm after the time t2 at which the current to the motor 10 is shut off. The electromotive force (the motor terminal voltage Vm) is generated corresponding to the output of the motor and thus gradually decreases over time.

With the characteristics of the motor after degradation, the motor terminal voltage Vm drops to, e.g., voltage V3 from stop of the motor (the time t2) to the time t3 which is the point when the time Δt elapses. The motor terminal voltage V3 has a relatively smaller value than V2 of the initial characteristics.

By the deriving unit 30, e.g., a ratio of the motor terminal voltage Vm at the time t3, which is the point when the time Δt elapses after the motor stops (the time t2), with respect to the driving voltage V0 of the motor 10 is detected and calculated as the determination ratio S_{D} of electric power to be supplied to the motor. The determination ratio S_{D} is input to the input port P2 of the control ECU 40.

The determination ratio S_{D} with the initial characteristics is V2/V0 as the waveform of the motor terminal voltage Vm in FIG. 2 shows, and the determination ratio S_{D} after degradation of the motor characteristics is V3/V0 as the waveform of the motor terminal voltage Vm in FIG. 3 shows.

Based on the determination ratio S_{D}, the adjusting unit 45 adjusts electric power to be supplied to the motor 10. The adjusting unit 45 can be configured to perform adjustment when the determination ratio S_{D} is not more than a threshold. The adjustment by the adjusting unit 45 in case of the determination ratio S_{D} of not more than the threshold will be described below.

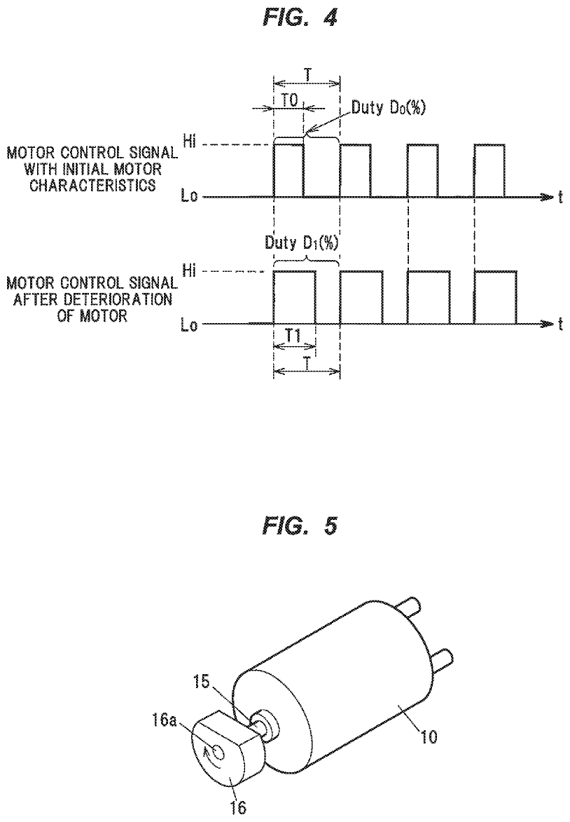

The adjusting unit 45 performs correction such that the motor control signal (PWM signal) used for the initial characteristics of the motor shown in FIG. 4 is corrected to the motor control signal (PWM signal) used after degradation of the motor shown in FIG. 4. The duty ratio is corrected in such a manner that, e.g., a PWM signal with the duty ratio Do having a period T and a pulse width T0 is corrected to a PWM signal with a duty ratio Di having the period T and a pulse width T1. In other words, the adjusting unit 45 can decide the duty ratio so that voltage is increased by the amount decreased from the driving voltage V0 to the detected voltage (V0-V3). The corrected duty ratio can be stored in the control ECU 40 and the motor can be driven with this duty ratio until the duty ratio is updated.

The adjusting unit 45 can store and have, e.g., in the control ECU 40, a correction table containing the determination ratios S_{D} and the duty ratios associated therewith. The adjusting unit 45 can reference the correction table and decide the duty ratio based on the determination ratio S_{D}.

As a waveform of the motor ON/OFF signal V_{ONOFF} in FIG. 3 shows, after degradation of the motor, electric power supply for the next time the motor 10 is turned on (starts rotating), i.e., electric power supply from time t4 onwards is adjusted based on the detection result of the transient characteristics of the motor terminal output after the motor 10 is turned off (stops rotating), thereby correcting the motor characteristics.

As shown in FIG. 3, the motor control signal Vs is corrected to have the duty ratio Di. In addition, by correcting the duty ratio Di, the rotational speed of the motor 10 returns to, e.g., the rotational speed α which is the initial characteristic of the motor.

Although the above-described adjustment of electric power supplied to the motor by the adjusting unit 45 is achieved by correcting the duty ratio based on the determination ratio S_{D}, it is not limited thereto. For example, electric power may be adjusted by correcting the duty ratio as well as correcting gain (voltage).

(Determination of Abnormality in the Motor)

The adjusting unit 45 can have a specified value in, e.g., the control ECU 40, which is used to determine that abnormality is occurring when the determination ratio S_{D} is not more than the specified value. Based on comparison of the specified value with the determination ratio S_{D}, the adjusting unit 45 can determine that abnormality is occurring in the motor, and according to circumstances, the adjusting unit 45 can stop the motor from being driven.

### APPLICATION EXAMPLES

The motor control device 1 in the present embodiment is applicable to various motors, and is effectively applicable to, e.g., a vibration motor as shown in FIG. 5.

As an example, the vibration motor 10 shown in FIG. 5 is configured that a rotating body 16 is attached to a motor rotating shaft 15 through an attachment hole 16a. As shown in FIG. 5, the rotating body 16 has a non-circular shape and the center of gravity of the rotating body 16 does not coincide with the motor rotating shaft 15. When the vibration motor 10 in such a state is rotationally driven, the entire vibration motor 10 vibrates. It is thereby possible to provide vibration.

In case of the vibration motor 10 described above, a bearing rotationally supporting the motor rotating shaft 15 is worn, etc., causing an increase in frictional torque inside the motor and a decrease in vibration level. Thus, by applying the motor control device 1 in the present embodiment, it is possible to suppress the decrease in vibration level.

### Effects of the Embodiment

The embodiment of the invention exerts the following effects.

(1) The motor control device 1 in the embodiment of the invention has the motor control unit 20 which controls electric power to be supplied to the motor 10, the deriving unit 30 which derives a determination ratio of electric power to be supplied to the motor 10 based on a detection result of transient characteristics of terminal output of the motor 10 which are obtained under a predetermined condition after electric power supply from the motor control unit 20 to the motor 10 is shut off, and the adjusting unit 45 which adjusts electric power to be supplied to the motor 10 based on the determination ratio. Since the electric power to be supplied to the motor 10 is adjusted based on the detection result of the transient characteristics of terminal output of the motor 10, deterioration in the motor characteristics due to aging degradation of the motor can be suppressed. This also extends system lifetime.

(2) What is described above can be achieved by electric power adjustment by the adjusting unit 45, e.g., correction of the duty ratio of motor driving voltage. Therefore, it is also effective to avoid an increase in cost caused by increasing motor durability, etc.

(3) When the motor control device 1 in the present embodiment is applied to a vibration motor, a decrease in vibration level due to aging degradation of the motor can be suppressed. This also extends system lifetime of the vibration motor.

Although some embodiments of the invention have been described above, the embodiments are merely an example and the invention according to claims is not to be limited thereto. These new embodiments may be implemented in various other forms, and various omissions, substitutions and changes, etc., can be made without departing from the gist of the invention. In addition, all combinations of the features described in these embodiments are not necessary to solve the problem of the invention. Further, these embodiments are included within the scope and gist of the invention and also within the invention described in the claims and the equivalency thereof.

### REFERENCE SIGNS LIST

1 MOTOR CONTROL DEVICE
10 MOTOR
11, 12 TERMINAL
20 MOTOR CONTROL UNIT
21 TRANSISTOR
30 DERIVING UNIT
40 CONTROL ECU
45 ADJUSTING UNIT
S_{D} DETERMINATION RATIO

1. A motor control device, comprising:
a motor control unit that controls electric power to be supplied to a motor;
a deriving unit that derives a determination ratio of electric power to be supplied to the motor based on a detection result of transient characteristics of terminal output of the motor obtained under a predetermined condition after electric power supply from the motor control unit to the motor is shut off; and
an adjusting unit that adjusts electric power to be supplied to the motor based on the determination ratio.

2. The motor control device according to claim 1, wherein the deriving unit derives the determination ratio of electric power to be supplied to the motor based on an electromotive force generated in a terminal of the motor at the point when a predetermined time elapses after the electric power supply from the motor control unit to the motor is shut off.

3. The motor control device according to claim 1, wherein the deriving unit derives the determination ratio of electric power to be supplied to the motor based on time from when the electric power supply from the motor control unit to the motor is shut off to when the electromotive force generated in the terminal of the motor drops to a specified voltage.

4. The motor control device according to claim 1, wherein the adjusting unit performs the adjustment when the determination ratio is not more than a threshold.

5. The motor control device according to claim 1, wherein the motor control unit performs PWM control to control a duty ratio of electric power to be supplied to the motor.

6. The motor control device according to claim 5, wherein the adjusting unit decides the duty ratio so that voltage is increased by the amount decreased from a reference voltage to a detected voltage.

7. The motor control device according to claim 5, wherein the adjusting unit decides the duty ratio and gain (voltage) so that voltage is increased by the amount decreased from a reference voltage to a detected voltage.

8. The motor control device according to claim 6, wherein the adjusting unit comprises a correction table containing the determination ratios and the duty ratios associated therewith and decides the duty ratio based on the determination ratio by referencing the correction table.

9. The motor control device according to claim 1, wherein, when the determination ratio is not more than a specified value, the adjusting unit determines that abnormality is occurring in the motor.

10. The operation detection device according to claim 1, wherein the motor comprises a vibration motor.

11. The motor control device according to claim 7, wherein the adjusting unit comprises a correction table containing the determination ratios and the duty ratios associated therewith and decides the duty ratio based on the determination ratio by referencing the correction table.
